(19) United States
(12) Patent Application Publication
(10) Pub. No.: US 2025/0141246 A1
(43) Pub. Date: May 1, 2025

(54) PORTABLE MULTIPLE OUTLET CHARGING DEVICE

(71) Applicant: Anthony Daniels, Austin, TX (US)

(72) Inventor: Anthony Daniels, Austin, TX (US)

(21) Appl. No.: 18/383,682

(22) Filed: Oct. 25, 2023

(51) Int. Cl. H02J 7/00

(52) U.S. Cl. CPC H02J 7/0045; H02J 7/0013

(57) ABSTRACT

A portable multiple outlet charging device includes a box that has a handle which is attached to the box and a spool housing that is attached to the box. A charging unit is integrated into the box and a charge cord is pluggable into a power source for charging the charging unit. In this way the charging unit facilitates electrical power to be available in a remote location when the box is transported to the remote location. A plurality of first charge ports and a plurality of second charge ports is each recessed into the box to receive a respective first type of charge cord and a second type of charge cord. Each of the plurality of first charge ports can charge electronic devices which employ the first type of charge cord and each of the plurality of second charge ports can charge plurality of electronic devices which employ the second type of charge cord.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to portable charging devices and more particularly pertains to a new portable charging device for charging or powering electronic devices in a remote location. The device includes a box and a charging unit integrated into the box and charge cord for charging unit. The device includes a plurality of first charge ports recessed into the box and a plurality of second charge ports recessed into the box for charging various electronic devices. The device includes fluorescent strips on the box and a light emitter on the box.

### (2) Description of Related Art including information disclosed under 37 CFR 1.97 and 1.98.

The prior art relates to portable charging devices including a variety of portable charging devices that each includes an internal rechargeable battery and a plurality of charging ports for charging a plurality of electronic devices. In no instance does the prior art disclose a portable charging device that includes an internal rechargeable battery, a plurality of first charge ports, a plurality of second charge ports, a plurality of fluorescent strips and a light.

### BRIEF SUMMARY OF THE INVENTION

An embodiment of the disclosure meets the needs presented above by generally comprising a box that has a handle which is attached to the box and a spool housing that is attached to the box. A charging unit is integrated into the box and a charge cord is pluggable into a power source for charging the charging unit. In this way the charging unit facilitates electrical power to be available in a remote location when the box is transported to the remote location. A plurality of first charge ports and a plurality of second charge ports is each recessed into the box to receive a respective first type of charge cord and a second type of charge cord. Each of the plurality of first charge ports can charge electronic devices which employ the first type of charge cord and each of the plurality of second charge ports can charge plurality of electronic devices which employ the second type of charge cord.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a portable multiple outlet charging device according to an embodiment of the disclosure.

FIG. 2 is a bottom perspective view of an embodiment of the disclosure.

FIG. 3 is a left side view of an embodiment of the disclosure.

FIG. 4 is a cross sectional view taken along line 4-4 of FIG. 3 of an embodiment of the disclosure.

FIG. 5 is a magnified detail view of a light housing and a light of an embodiment of the disclosure.

FIG. 6 is a perspective in-use view of an embodiment of the disclosure.

FIG. 7 is a schematic view of an embodiment of the disclosure.

FIG. 8 is a perspective view of an alternative embodiment of the disclosure.

### DETAILED DESCRIPTION OF THE INVENTION

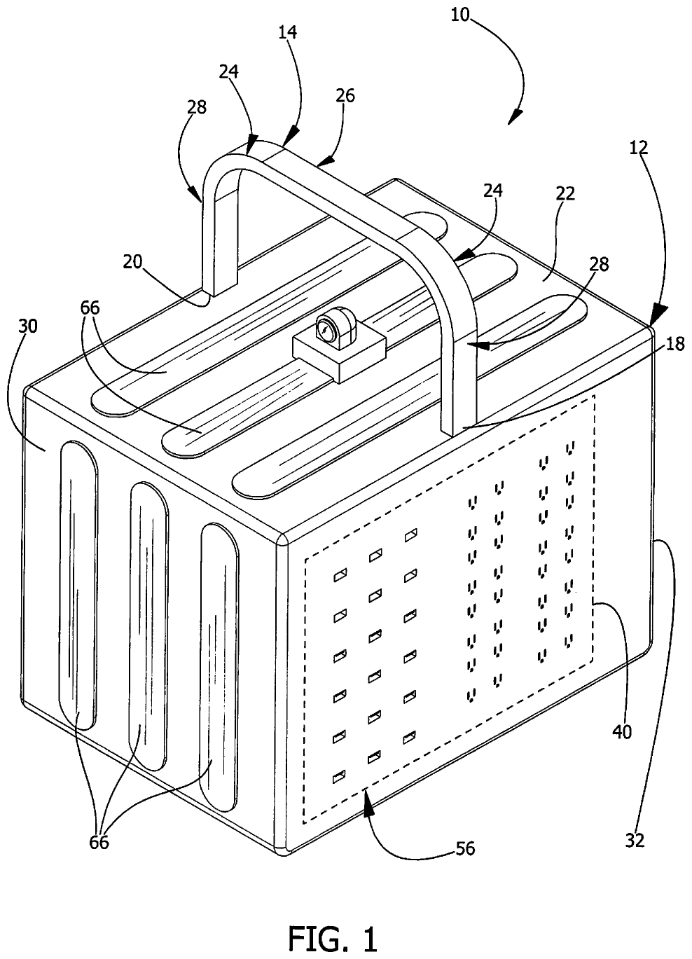

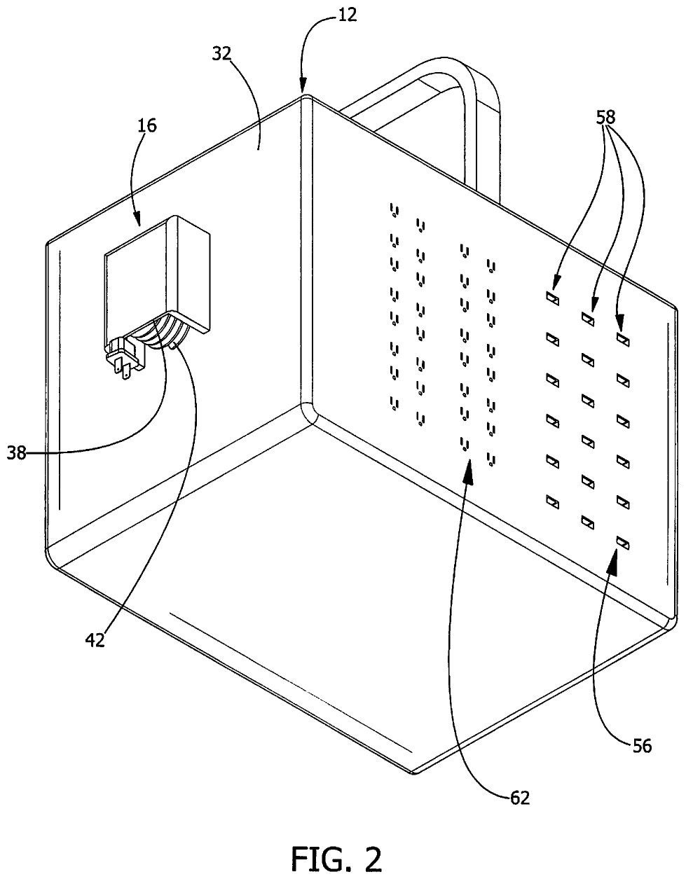

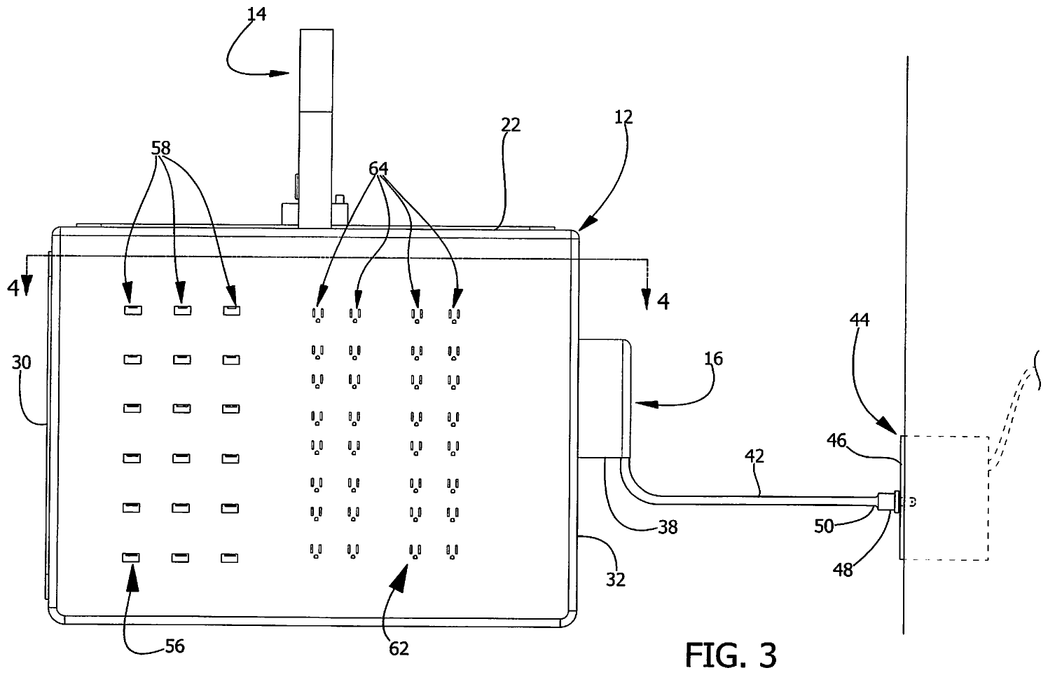

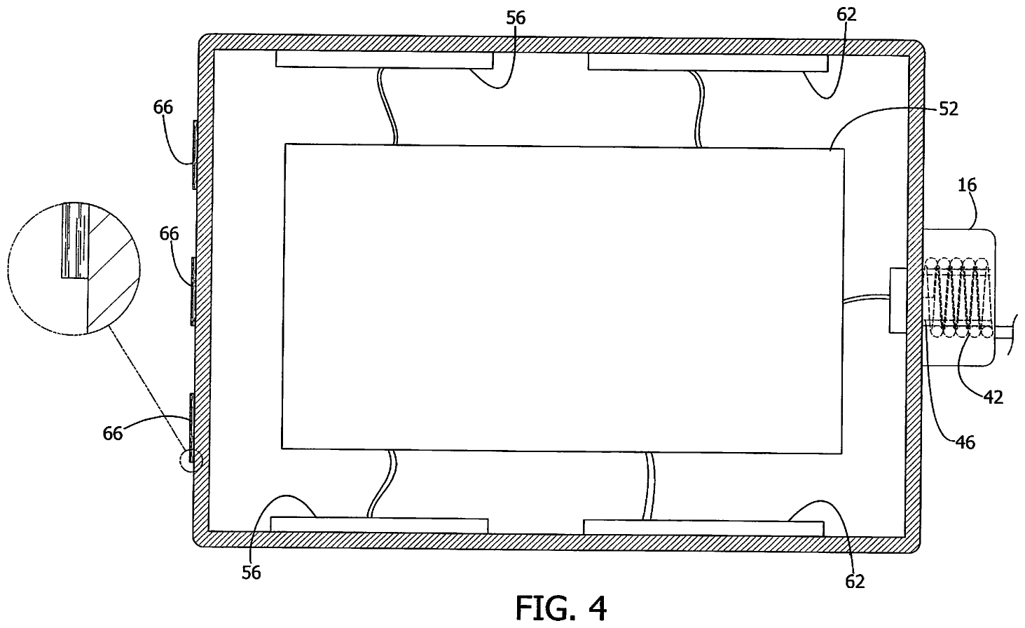

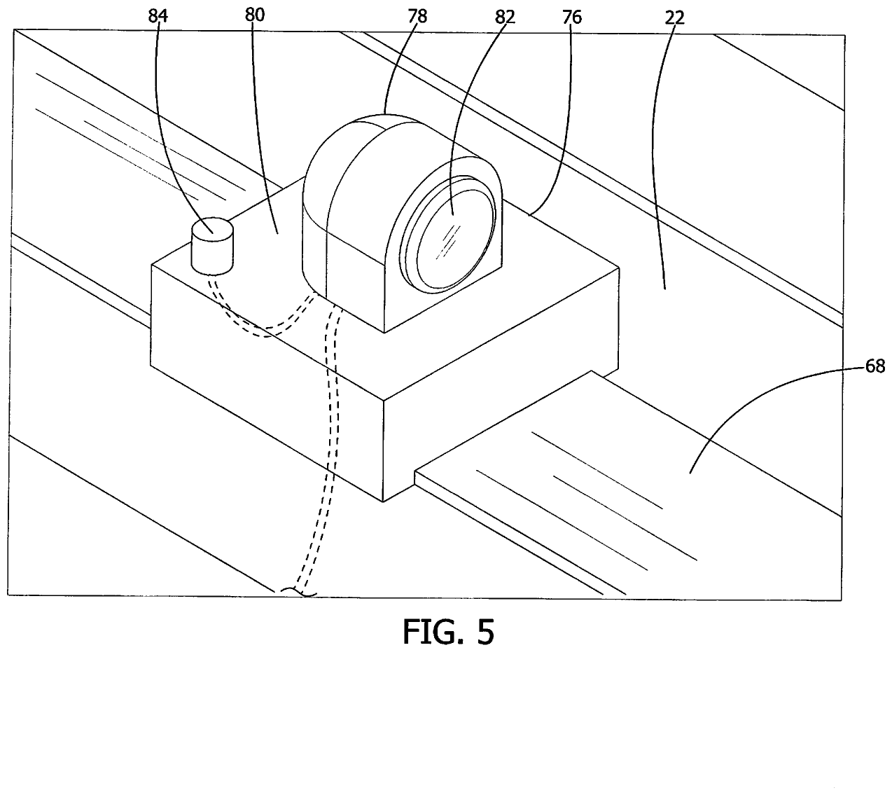

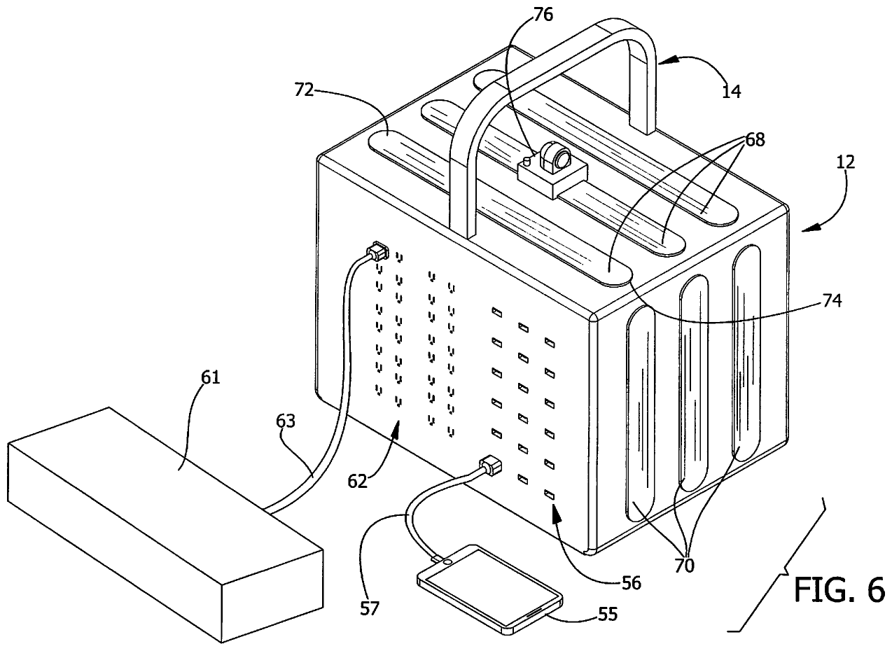

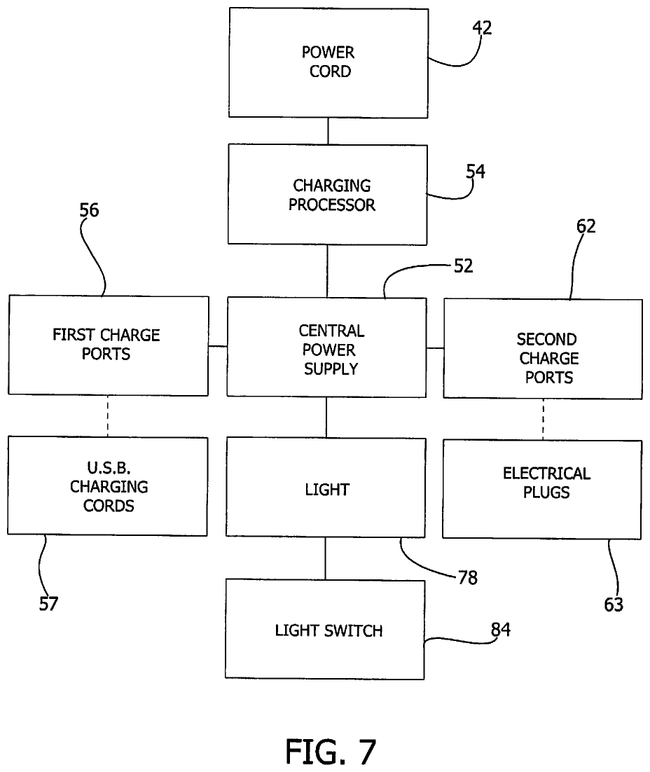

With reference now to the drawings, and in particular to FIGS. 1 through 8 thereof, a new portable charging device embodying the principles and concepts of an embodiment of the disclosure and generally designated by the reference numeral 10 will be described.

As best illustrated in FIGS. 1 through 8, the portable multiple outlet charging device 10 generally comprises a box 12 that has a handle 14 which is attached to the box 12 and a spool housing 16 that is attached to the box 12. The handle 14 has a first end 18 and a second end 20 that is each attached to a top wall 22 of the box 12 and the handle 14 has pair of curves 24 defining a central portion 26 extending between a pair of outward portions 28 such that the handle 14 has a U-shape. Each of the first end 18 and the second end 20 is associated with a respective one of the pair of outward portions 28 such that the central portion 26 is elevated above the top wall 22. The handle 14 is centrally located between a front wall 30 and a back wall 32 of the box 12 and the handle 14 is oriented such that each of the first end 18 and the second end 20 is aligned with a respective one of a first lateral wall 34 and a second lateral wall 36 of the box 12. Additionally, the spool housing 16 is positioned on the back wall 32 of the box 12 and the spool housing 16 has a lower end 38 that is open into an interior of the spool housing 16.

A charging unit 40 is integrated into the box 12 and the charging unit 40 has a charge cord 42 which is pluggable into a power source 44 comprising a female electrical outlet 45 for charging the charging unit 40. In this way the charging unit 40 facilitates electrical power to be available in a remote location when the box 12 is transported to the remote location. The charging unit 40 comprises a spool 46 that is rotatably disposed in the spool housing 16. The spool 46 is biased to rotate in a first direction and the spool 46 is urgeable to rotate in a second direction. Additionally, the charge cord 42 is wrapped around the spool 46 such that the spool 46 retracts the charge cord 42 into the spool housing 16 when the spool 46 is biased to rotate in the first direction. The charge cord 42 is drawable outwardly from the spool housing 16 thereby rotating the spool 46 in the second direction. A male plug 48 is electrically coupled to a distal end 50 of the charge cord 42 thereby facilitating the male plug 48 to be electrically mated to the female electrical outlet 45.

The charging unit 40 includes a rechargeable battery 52 that is positioned within the box 12. The charge cord 42 is electrically coupled to the rechargeable battery 52 thereby facilitating the rechargeable battery 52 to be charged when the charge cord 42 is plugged into the female electrical outlet 45. The rechargeable battery 52 may have an ampere rating ranging between approximately 20.0 ampere hours and 30.0 ampere hours. Additionally, the charging unit 40 includes a charging processor 54 to control the charging process of the rechargeable battery 52 and the charging processor 54 may comprise control circuity that is common to battery chargers.

A plurality of first charge ports 56 is each recessed into the box 12 and each of the first charge ports 56 can receive a first type of charge cord 57. Each of the plurality of first charge ports 56 is in communication with the charging unit 40 to facilitate a plurality of personal electronic devices 55 to be charged which employ the first type of charge cord 57. Each of the plurality of first charge ports 56 is electrically coupled to the rechargeable battery 52. The plurality of first charge ports 56 is arranged in a plurality of columns 58 which extend substantially between the top wall 22 of the box 12 and a bottom wall 60 of the box 12 and the plurality of first charge ports 56 is positioned closer to the front wall 30 of the box 12 than the back wall 32 of the box 12. Furthermore, the plurality of first charge ports 56 is integrated into each of the first lateral wall 34 of the box 12 and the second lateral wall 36 of the box 12. Each of the set of first charge ports 56 may comprise a universal serial bus port or other type of charge port commonly associated with personal electronic devices 55 such as smart phones.

A plurality of second charge ports 62 is each of the plurality of second charge ports 62 is recessed into the box 12 and each of the plurality of second charge ports 62 can receive a second type of charge cord 63. Additionally, each of the plurality of second charge ports 62 is in communication with the charging unit 40 to facilitate a plurality of electronic devices 61 to be charged which employ the second type of charge cord 63. Each of the plurality of second charge ports 62 is electrically coupled to the rechargeable battery 52. The plurality of second charge ports 62 is arranged in a plurality of columns 64 which extend substantially between the top wall 22 of the box 12 and a bottom wall 60 of the box 12 and the plurality of second charge ports 62 is positioned between the plurality of first charge ports 56 and the back wall 32 of the box 12. Additionally, each of the plurality of second charge ports 62 is integrated into the first lateral wall 34 of the box 12 and the second lateral wall 36 of the box 12. Each of the set of second charge ports 62 may comprise a three prong female electrical outlet to facilitate electronic devices 61, such as laptop computer for example, to be powered.

A plurality of fluorescent strips 66 is each applied to the box 12 and each of the plurality of fluorescent strips 66 emits light outwardly from the box 12. The plurality of fluorescent strips 66 includes a set of first fluorescent strips 68 positioned on the top wall 22 of the box 12. Each of the first fluorescent strips 68 is elongated to extend substantially between the front wall 30 and the back wall 32. The plurality of fluorescent strips 66 includes a set of second fluorescent strips 70 positioned on the front wall 30 of the box 12. Each of the second fluorescent strips 70 is elongated to extend substantially between the top wall 22 and the bottom wall 60. Additionally, each of the first fluorescent strips 68 and the second fluorescent strips 70 may be comprised of a fluorescent material that can be charged with a light source, such as the sun or an electronic light for example, thereby facilitating the first fluorescent strips 68 and the second fluorescent strips 70 to emit light in a darkened environment. Furthermore, each of the first fluorescent strips 68 and the second fluorescent strips 70 has a first end 72 that is rounded and a second end 74 that is rounded.

A light housing 76 is attached to the top wall 22 of the box 12 and the light housing 76 is positioned on a respective one of the first fluorescent strips 68. A light 78 is attached to an upper wall 80 of the light housing 76 and the light 78 emits light outwardly from the light housing 76 when the light 78 is turned on. The light 78 includes a lens 82 that is directed toward the front wall 30 of the box 12 and the light 78 may comprise a light emitting diode or other type of electronic light emitter. A light switch 84 is movably integrated into the upper wall 80 of the light housing 76 and the light switch 84 is electrically coupled between the light 78 and the rechargeable battery 52. Additionally, the light switch 84 actuates and de-actuates the light 78 when the light switch 84 is manipulated between an on position and an off position.

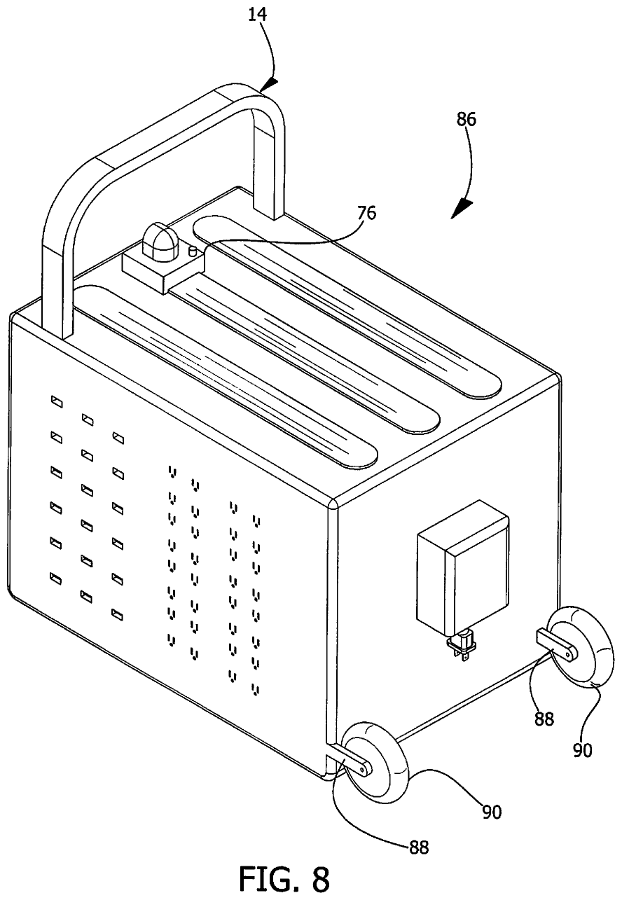

In an alternative embodiment 86 shown in FIG. 8, a pair of wheel mounts 88 extends away from the back wall 32 of the box 12 at a point aligned with an intersection between the bottom wall 60 and a respective one of the first lateral wall 34 and the second lateral wall 36 of the box 12. A pair of wheels 90 is each rotatably coupled to a respective one of the wheel mounts 88 to facilitate the box 12 to be rolled on each of the wheels 90. Continuing in the alternative embodiment, each of the light housing 76 and the handle 14 is positioned adjacent to the front wall 30 of the box 12.

In use, the charge cord 42 is plugged into the power source 44 for a sufficient duration of time to charge the rechargeable battery 52. The box 12 is transported to a remote location and a large number of personal electronic devices 55 can be charged with the set of first charge ports 56 and a large number of electronic devices 61 can be powered with the set of second charge ports 62. In this way nearly any electrical power needs can be satisfied in a remote location that does not have access to electricity. The fluorescent strips 66 enhance visibility of the box 12 in a darkened environment and the light 78 can be turned on to illuminate a dark area.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable multiple outlet charging device for simultaneously charging a variety of electronic devices, said device comprising:
a box having a handle being attached to said box and a spool housing being attached to said box;
a charging unit being integrated into said box, said charging unit being having a charge cord which is pluggable into a power source comprising a female electrical outlet for charging said charging unit wherein said charging unit is configured to facilitate electrical power to be available in a remote location when said box is transported to the remote location;
a plurality of first charge ports, each of said plurality of first charge ports being recessed into said box wherein each of said plurality of first charge ports is configured to receive a first type of charge cord, each of said plurality of first charge ports being in communication with said charging unit wherein said plurality of first charge ports is configured to facilitate a plurality of electronic devices to be charged which employ the first type of charge cord;
a plurality of second charge ports, each of said plurality of second charge ports being recessed into said box wherein each of said plurality of second charge ports is configured to receive a second type of charge cord, each of said plurality of second charge ports being in communication with said charging unit wherein said plurality of second charge ports is configured to facilitate a plurality of electronic devices to be charged which employ the second type of charge cord; and
a plurality of fluorescent strips, each of said plurality of fluorescent strips being applied to said box wherein each of said plurality of fluorescent strips is configured to emit light outwardly from said box.

2. The device according to claim 1, wherein:
said handle has a first end and a second end each being attached to a top wall of said box;
said handle has pair of curves defining a central portion extending between a pair of outward portions such that said handle has a U-shape;
each of said first end and said second end is associated with a respective one of said pair of outward portions such that said central portion is elevated above said top wall;
said handle is centrally located between a front wall and a back wall of said box;
said handle is oriented such that each of said first end and said second end is aligned with a respective one of a first lateral wall and a second lateral wall of said box;
said spool housing is positioned on said back wall of said box; and
said spool housing has a lower end being open into an interior of said spool housing.

3. The device according to claim 2, wherein:
said charging unit comprises:
a spool being rotatably disposed in said spool housing, said spool being biased to rotate in a first direction, said spool being urgeable to rotate in a second direction; and
a rechargeable battery being positioned within said box, said charge cord being electrically coupled to said rechargeable battery thereby facilitating said rechargeable battery to be charged when said charge cord is plugged into the female electrical outlet;
said power cord is wrapped around said spool such that said spool retracts said power cord into said spool housing when said spool is biased to rotate in said first direction;
said power cord is drawable outwardly from said spool housing thereby rotating said spool in said second direction; and
said power cord has a male plug being electrically coupled to a distal end of said power cord thereby facilitating said male plug to be electrically mated to the female electrical outlet.

4. The device according to claim 2, wherein:
each of said plurality of first charge ports is electrically coupled to said rechargeable battery;
said plurality of first charge ports is arranged in a plurality of columns which extend substantially between said top wall of said box and a bottom wall of said box;
said plurality of first charge ports is positioned closer to said front wall of said box than said back wall of said box; and
said plurality of first charge ports is integrated into said first lateral wall of said box and said second lateral wall of said box.

5. The device according to claim 2, wherein:
each of said plurality of second charge ports is electrically coupled to said rechargeable battery;
said plurality of second charge ports is arranged in a plurality of columns which extend substantially between said top wall of said box and a bottom wall of said box;
said plurality of second charge ports is positioned between said plurality of first charge ports and said back wall of said box; and
each of said plurality of second charge ports is integrated into said first lateral wall of said box and said second lateral wall of said box.

6. The device according to claim 2, wherein:
said plurality of fluorescent strips includes a set of first fluorescent strips being positioned on said top wall of said box;
each of said first fluorescent strips is elongated to extend substantially between said front wall and said back wall;
said plurality of fluorescent strips includes a set of second fluorescent strips being positioned on said front wall of said box; and
each of said second fluorescent strips is elongated to extend substantially between said top wall and said bottom wall.

7. The device according to claim 6, further comprising a light housing being attached to said top wall of said box, said light housing being positioned on a respective one of said first fluorescent strips.

8. The device according to claim 7, further comprising a light being attached to an upper wall of said light housing wherein said light is configured to emit light outwardly from said light housing when said light is turned on, said light including a lens being directed toward said front wall of said box.

9. The device according to claim 8, wherein:
said charging unit includes a rechargeable battery being positioned in said box; and
said device includes a light switch being movably integrated into said upper wall of said light housing, said light switch being electrically coupled between said light and said rechargeable battery, said light switch actuating and de-actuating said light when said light switch is manipulated between an on position and an off position.

10. A portable multiple outlet charging device for simultaneously charging a variety of electronic devices, said device comprising:
a box having a handle being attached to said box and a spool housing being attached to said box, said handle having a first end and a second end each being attached to a top wall of said box, said handle having pair of curves defining a central portion extending between a pair of outward portions such that said handle has a U-shape, each of said first end and said second end being associated with a respective one of said pair of outward portions such that said central portion is elevated above said top wall, said handle being centrally located between a front wall and a back wall of said box, said handle being oriented such that each of said first end and said second end is aligned with a respective one of a first lateral wall and a second lateral wall of said box, said spool housing being positioned on said back wall of said box, said spool housing having a lower end being open into an interior of said spool housing;
a charging unit being integrated into said box, said charging unit being having a charge cord which is pluggable into a power source comprising a female electrical outlet for charging said charging unit wherein said charging unit is configured to facilitate electrical power to be available in a remote location when said box is transported to the remote location, said charging unit comprising:
a spool being rotatably disposed in said spool housing, said spool being biased to rotate in a first direction, said spool being urgeable to rotate in a second direction, said power cord being wrapped around said spool such that said spool retracts said power cord into said spool housing when said spool is biased to rotate in said first direction, said power cord being drawable outwardly from said spool housing thereby rotating said spool in said second direction, said power cord having a male plug being electrically coupled to a distal end of said power cord thereby facilitating said male plug to be electrically mated to the female electrical outlet; and
a rechargeable battery being positioned within said box, said charge cord being electrically coupled to said rechargeable battery thereby facilitating said rechargeable battery to be charged when said charge cord is plugged into the female electrical outlet;
a plurality of first charge ports, each of said plurality of first charge ports being recessed into said box wherein each of said plurality of first charge ports is configured to receive a first type of charge cord, each of said plurality of first charge ports being in communication with said charging unit wherein said plurality of first charge ports is configured to facilitate a plurality of electronic devices to be charged which employ the first type of charge cord, each of said plurality of first charge ports being electrically coupled to said rechargeable battery, said plurality of first charge ports being arranged in a plurality of columns which extend substantially between said top wall of said box and a bottom wall of said box, said plurality of first charge ports being positioned closer to said front wall of said box than said back wall of said box, said plurality of first charge ports being integrated into said first lateral wall of said box and said second lateral wall of said box;
a plurality of second charge ports, each of said plurality of second charge ports being recessed into said box wherein each of said plurality of second charge ports is configured to receive a second type of charge cord, each of said plurality of second charge ports being in communication with said charging unit wherein said plurality of second charge ports is configured to facilitate a plurality of electronic devices to be charged which employ the second type of charge cord, each of said plurality of second charge ports being electrically coupled to said rechargeable battery, said plurality of second charge ports being arranged in a plurality of columns which extend substantially between said top wall of said box and a bottom wall of said box, said plurality of second charge ports being positioned between said plurality of first charge ports and said back wall of said box, each of said plurality of second charge ports being integrated into said first lateral wall of said box and said second lateral wall of said box;
a plurality of fluorescent strips, each of said plurality of fluorescent strips being applied to said box wherein each of said plurality of fluorescent strips is configured to emit light outwardly from said box, said plurality of fluorescent strips including a set of first fluorescent strips being positioned on said top wall of said box, each of said first fluorescent strips being elongated to extend substantially between said front wall and said back wall, said plurality of fluorescent strips including a set of second fluorescent strips being positioned on said front wall of said box, each of said second fluorescent strips being elongated to extend substantially between said top wall and said bottom wall;
a light housing being attached to said top wall of said box, said light housing being positioned on a respective one of said first fluorescent strips;
a light being attached to an upper wall of said light housing wherein said light is configured to emit light outwardly from said light housing when said light is turned on, said light including a lens being directed toward said front wall of said box; and
a light switch being movably integrated into said upper wall of said light housing, said light switch being electrically coupled between said light and said rechargeable battery, said light switch actuating and de-actuating said light when said light switch is manipulated between an on position and an off position.

11. The device according to claim 9, further comprising a pair of wheel mounts extending away from said back wall of said box at a point aligned with an intersection between said bottom wall and a respective one of said first lateral wall and said second lateral wall of said box.

12. The device according to claim 10, further comprising a pair of wheels is each rotatably coupled to a respective one of said wheel mounts to facilitate said box to be rolled on each of said wheels.

13. The device according to claim 10, wherein each of said light housing and said handle is positioned adjacent to said front wall of said box.
